(19) United States
(12) Patent Application Publication
(10) Pub. No.: US 2026/0049683 A1
(43) Pub. Date: Feb. 19, 2026

(54) Insulated Conduit

(71) Applicant: Osterman & Company, Inc., Cheshire, CT (US)

(72) Inventor: Swapnil B. Chandak, Pearland, TX (US)

(21) Appl. No.: 18/804,792

(22) Filed: Aug. 14, 2024

(51) Int. Cl. F16L 59/02

(52) U.S. Cl. CPC F16L 59/028

(57) ABSTRACT

An insulated conduit application includes a pipe for transporting a fluid, the pipe defining an interior surface and an exterior surface. The insulated conduit further includes a crosslinked insulation layer disposed about the exterior surface of the pipe. The crosslinked insulation layer includes a polyethylene composition, with the polyethylene composition having a density of from 0.9125 to 0.9200 (g/cm³), a melt flow ratio (MFR) of 30 to 70, and a melt index of from 0.3 to 1.8 (I2.16 kg).

### FIELD OF THE DISCLOSURE

The present disclosure generally relates to a conduit for transporting a fluid, with the conduit including an insulation layer including a polyethylene composition.

### BACKGROUND

Certain grades of polyethylene are known to be suitable for forming a foam that has insulating properties. Certain insulation applications, such as applications directed to HVAC conduits, rely on polyethylene compositions which have not been optimized for cost, performance, or both. Thus, there remains an opportunity to develop an improved insulation composition from polyethylene.

### SUMMARY OF THE DISCLOSURE

This Summary introduces a selection of concepts in a simplified form that are further described below in the Detailed Description. This Summary is not intended to limit the scope of the claimed subject matter nor identify key features or essential features of the claimed subject matter.

According to a first aspect, an insulated conduit for HVAC applications includes a pipe for transporting a fluid. The pipe defines an interior surface and an exterior surface. The insulated conduit further includes a crosslinked insulation layer disposed about the exterior surface of the pipe. The crosslinked insulation layer comprising a polyethylene composition having a density of from 0.9125 to 0.9200 (g/cm³).

According to a second aspect, a method of forming an insulated conduit includes providing a pipe for transporting a fluid. The pipe defines an interior surface and an exterior surface. The method further includes providing a non-crosslinked polyethylene, the non-crosslinked polyethylene having a density of from 0.9125 to 0.9200 (g/cm³). The method further includes irradiating the non-crosslinked polyethylene to form a polyethylene composition. The polyethylene composition has a density of from 0.9125 to 0.9200 (g/cm³). The method further includes disposing the polyethylene composition about the exterior surface of the pipe to form an insulated layer about the conduit.

Any of the above aspects can be combined in part, or in whole, with any other aspect. Any of the aspects above can be combined in part, or in whole, with any of the following implementations.

In one implementation, the polyethylene composition has a melt flow ratio (MFR I21.6/I2.16) of 30 to 70.

In one implementation, the polyethylene composition has a melt index of from 0.3 to 1.8 (12.16 kg).

In one implementation, the polyethylene composition has a density of from 0.9125 to 0.9180 (g/cm³).

In one implementation, the polyethylene composition has a density of from 0.9125 to 0.9170 (g/cm³).

In one implementation, the polyethylene composition has a melt index of 0.3 to 1.8 (I2.16 kg).

In one implementation, the polyethylene composition has a melt index of 0.4 to 1.3 (I2.16 kg).

In one implementation, the polyethylene composition has a melt flow ratio of 35 to 65.

In one implementation, the polyethylene composition has a polydispersity index of from 2.0 to 3.5.

In one implementation, the polydispersity index of the polyethylene composition is from 2.3 to 2.5.

In one implementation, the polyethylene composition has a melt index of 0.3 to 18 (I2.16 kg), a melt flow rate of 35 to 65, a polydispersity of from 2.3 to 2.5, and a density of from 0.9125 to 0.9170 (g/cm³).

In one implementation, the polyethylene composition of the crosslinked insulation layer is formed from a polyethylene that prior to crosslinking had a density of 0.9125 to 0.9200 (g/cm³), a melt flow rate of 30 to 70, and a melt index of 0.3 to 1.8 (I2.16 kg).

In one implementation, the non-crosslinked polyethylene had a density of 0.9125 to 0.9170, a melt flow rate of 17 to 22, and a melt index of 3.0 to 6.5 (I2.16 kg).

In one implementation, the non-crosslinked polyethylene had a polydispersity index of from 2.2 to 2.7.

Any of the above aspects can be combined in full or in part. Any features of the above aspects can be combined in full or in part. Any of the above implementations for any aspect can be combined with any other aspect. Any of the above implementations can be combined with any other implementation whether for the same aspect or a different aspect.

### BRIEF DESCRIPTION OF THE DRAWINGS

Advantages of the present invention will be readily appreciated, as the same becomes better understood by reference to the following detailed description, when considered in connection with the accompanying drawings.

FIG. 1 provides a scatter plot showing shear viscosity vs. shear rate for an insulative layer falling within the scope of this disclosure vs. a control sample.

FIG. 2 provides another scatter plot showing shear viscosity vs. shear rate for two insulative layers falling within the scope of this disclosure vs. a control sample.

### DETAILED DESCRIPTION OF THE DISCLOSURE

The present disclosure provides an insulated conduit. Typically, the insulated conduit is used for HVAC applications. The insulated conduit includes a pipe for transporting a fluid. Although not required, the insulated conduit is typically coupled on one end to an air conditioner that resides outside of a structure or dwelling and an interior furnace or air handler system. The fluid carried by the insulated conduit may be liquid refrigerant under pressure or refrigerant gas. However, the disclosure is not limited to any particular type of fluid.

The pipe defines an interior surface and an exterior surface, opposite the interior surface. In other words, the interior surface defines the channel that allows the fluid to travel along the pipe. The exterior surface faces away from the interior surface. The pipe is typically formed of copper, but other metals are contemplated.

A crosslinked insulation layer is disposed about the exterior surface of the pipe. The crosslinked insulation layer typically covers the entire exterior surface, with the exception of the ends that are used to couple to various components. The crosslinked insulation layer includes a polyethylene composition. For the purposes of this disclosure, reference to the polyethylene composition means a polyethylene composition that has been crosslinked, for example, with an electron beam or chemical crosslinking. Typically, an electron beam is utilized to crosslink the composition, such that the composition may also be referred to as irradiated.

The polyethylene composition includes a polyethylene polymer. The polyethylene polymer is derived from at least 85 mol % of ethylene monomer units. When a comonomer is utilized, the comonomer is one or more suitable alpha olefins such as but not limited to 1-butene, 1-hexene, 1-octene and the like, with 1-octene being preferred. Because the amount of ethylene in the polyethylene polymer is high, the polymer is simply referred to as polyethylene. However, it should be appreciated that the polyethylene polymer may also be referred to as an ethylene copolymer derived from at least 85 mol % of ethylene monomer and 15 mol. % or less of one or more alpha olefin monomers.

The polyethylene composition has a density of from 0.9125 to 0.9200 (g/cm³). Alternatively, the density of the polyethylene composition may be of from 0.9125 to 0.9180 or of from 0.9125 to 0.9170.

The polyethylene composition may have a melt index of from 0.3 to 1.8 (12.16 kg). Alternatively, the polyethylene composition has a melt index of from 0.3 to 1.5 or 0.4 to 1.3 (12.16 kg).

The polyethylene composition may have a melt flow ratio (MFR) of from 30 to 70 (I21/I2.16). Alternatively, the polyethylene composition has a MFR of from 35 to 65 (I21/I2.16). For the purposes of this disclosure, any reference to melt flow rate (MFR) means the melt flow rate as defined and measured in ASTM D1238.

The polyethylene composition may also have a polydispersity index of from 2.0 to 3.5 or alternatively, from 2.5 to 3.3. For the purposes of this disclosure, any reference to polydispersity index is the polydispersity index as measured by and defined in ASTM D6474—Standard Test Method for Determining Molecular Weight Distribution and Molecular Weight Averages of Polyolefins by High Temperature Gel Permeation Chromatography.

As described above, the polyethylene composition is crosslinked, such as by crosslinking with a suitable energy source, such as, for example, an electron beam. For ease of description, the pre-crosslinked composition that becomes the polyethylene composition upon crosslinking (e.g., irradiation) is referred to as the non-crosslinked polyethylene throughout this disclosure. The non-crosslinked polyethylene will now be described in further detail.

The non-crosslinked polyethylene has the same monomer makeup as the polyethylene composition, but different physical properties, due to the impact of irradiation/crosslinking on the composition. In particular, the non-crosslinked polyethylene may have a density of from 0.9125 to 0.9200 (g/cm³), a melt flow ratio of from 15 to 25, and a melt index of from 2.0 to 10.0. Alternatively, the non-crosslinked polyethylene may have a melt flow ratio of from 17 to 22 or a melt index of 3.0 to 6.5, or a combination thereof. The non-crosslinked polyethylene may also have a polydispersity index of from 2.0 to 3.0, or alternatively of from 2.2 to 2.7.

The insulation layer may also include additives in addition to the polyethylene composition. Optionally, additives can be added to the non-crosslinked polyethylene that forms the polyethylene composition. Additives can be added during a process step, such as molding, extrusion or compounding step, but other suitable known methods will be apparent to a person skilled in the art. Suitable additives are known in the art and include but are not limited to antioxidants, phosphites and phosphonites, nitrones, antacids, UV light stabilizers, UV absorbers, metal deactivators, dyes, fillers and reinforcing agents, nano-scale organic or inorganic materials, antistatic agents, lubricating agents such as calcium or zinc stearates, slip additives such as erucimide, and nucleating agents (including nucleators, pigments or any other chemicals which may provide a nucleating effect). The additives that can be optionally added are typically added in amount of up to 20 weight percent (wt %).

One or more nucleating agent(s) may be introduced into the non-crosslinked polyethylene by kneading a mixture of the polymer, usually in powder or pellet form, with the nucleating agent, which may be utilized alone or in the form of a concentrate containing further additives such as stabilizers, pigments, antistatics, UV stabilizers and fillers. It should be a material which is wetted or absorbed by the polymer, which is insoluble in the polymer and of melting point higher than that of the polymer, and it should be homogeneously dispersible in the polymer melt in as fine a form as possible (1 to 10 Compounds known to have a nucleating capacity for polyolefins include salts of aliphatic monobasic or dibasic acids or arylalkyl acids, such as sodium succinate or aluminum phenylacetate; and alkali metal or aluminum salts of aromatic or alicyclic carboxylic acids such as sodium β-naphthoate. Another compound known to have nucleating capacity is sodium benzoate.

The present disclosure also provides a method of forming the insulated conduit. The method includes providing the pipe. The method further includes providing the non-crosslinked polyethylene. The method further includes crosslinking (e.g., irradiating) the non-crosslinked polyethylene to form the polyethylene composition and disposing the polyethylene composition about the exterior surface of the pipe to form an insulated layer about the conduit (i.e., the insulated conduit).

The method may further include passing the non-crosslinked polyethylene through an extruder to melt the non-crosslinked polyethylene. The molten polyethylene is then pushed through a die at the other end of the extruder. The die is responsible to establish the final shape and size of the conduit article. The molten polyethylene is cooled by air and cold water combination until its solidifies. The resulting conduit article is then passed through secondary steps consisting of trimming/sorting/QC inspection and final packaging.

### EXAMPLES

Experimental testing was conducted on a control polyethylene and polyethylene samples falling within the scope of this disclosure to evaluate melt index, density, MFR, and polydispersity index. Table I below presents the test result for non-irradiated samples.

TABLE I

| Test | — | Control | Sample 1 |
|---|---|---|---|
| Density | (g/cm3) | 0.9103 | 0.916 |
| Melt Index | I2 | 16.24 | 4.2 |
| | I21 | 358.95 | 84 |
| | MFR (I21/I2) | 22.1 | 20 |
| Polydispersity | n/a | 3.01 | 2.0-2.5 |
| index | | | |

The same physical properties were reevaluated using irradiated samples. Table II below provides the results. Sample 1 was irritated to the same level as the control. Sample 2 is the same composition as Sample 1, with the exception that Sample 2 was exposed to a higher degree of irradiation.

TABLE II

| Test | — | Control | Sample 1 | Sample 2 |
|---|---|---|---|---|
| Density | (g/cm3) | 0.909 | 0.9165 | 0.9163 |
| Melt Index | I2 | 1.19 | 1.06 | 0.65 |
| | I21 | 71.91 | 44.65 | 36.85 |
| | MFR (I21/I2) | 60.42 | 42.32 | 57.13 |
| Polydispersity | — | 3.82 | ~3 | ~3 |

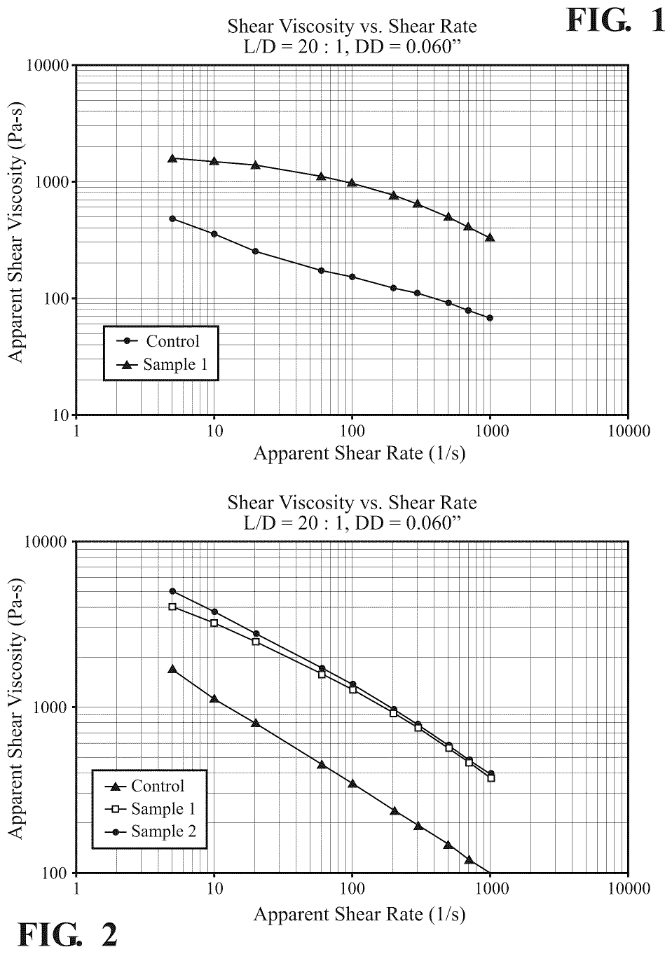

Rheological profiles of the non-crosslinked control and inventive non-crosslinked polyethylene. The rheological profiles are provided in FIG. 1. Rheological profiles were also generated for the irradiated control and irradiated inventive samples. The rheological profiles are provided in FIG. 2. The melt index of sample I measured at 2.16 and 21.6 kg respectively in Table I is significantly lower than the control in Table I and the polydispersity index of the sample I in Table I is also significantly lower than the control sample in Table I, indicating the narrow molecular weight distribution achieved for Sample I.

Tensile strength and elongation were evaluated in accordance with ASTM D412. To perform the testing, 0.5 inch by 5.0 inch specimens were generated for each composition. Five specimens corresponding to irradiated sample 1, irradiated sample 2, and the irradiated control are shown below along with the break stress, yield stress, percent strain at break, and percent strain at yield. The data reported is the mean for the five specimens prepared from each composition and is shown below in Table III.

TABLE III

| | | | % Strain at | % Strain at |
|---|---|---|---|---|
| | Break Stress | Yield Stress | Break | yield |
| Specimen | (MPa) | (MPa) | (%) | (%) |
| Sample 1 | 0.24 | 0.15 | 91.59 | 14.79 |
| Sample 2 | 0.25 | 0.17 | 94.15 | 13.20 |
| Control | 0.17 | 0.10 | 77.30 | 13.99 |

Interestingly, despite the relatively similar density, melt index, and polydispersity index between the control and sample 1, sample 1 displayed significantly better performance in break stress, yield stress, % strain at break, and % strain at yield. Those of ordinary skill in the art will understand the importance of these physical properties within the context of insulated conduits, where the insulation layer is typically exposed to exterior forces while being applied to the pipe and through the general exposure of a typical environmentally accessible component of an HVAC system.

Additional testing was conducted on the irradiated specimens to determine compression strength on the irradiated specimens in accordance with ASTM D3575. Within this testing, the specimens were compressed to 25% of its thickness at 0.5 inches/min. The results of the testing are provided below in Table IV.

TABLE IV

| | Compression | Compression |
|---|---|---|
| | force at 25% | Strength |
| Specimen | thickness (lbf) | (psi) |
| Sample 1 | 13.12 | 2.47 |
| Sample 2 | 14.12 | 2.81 |
| Control | 10.27 | 2.04 |

As shown above, Sample 1 once again outperformed the control.

Additional testing was conducted on the irradiated specimens to determine compression set on the irradiated specimens in accordance with ASTM D3575. Within this testing, the specimens were compressed to 50% of its thickness within platens for 22 hours+/−30 minutes.

TABLE V

| | Compression | |
|---|---|---|
| | Deflection | Recovery |
| Specimen | (%) | (%) |
| Sample 1 | 9.21 | 90.79 |
| Sample 2 | 12.37 | 87.63 |
| Control | 17.36 | 82.64 |

As shown above, Sample 1 once again outperformed the control and exhibited a significantly better recovery.

Additional testing was conducted on the irradiated specimens using Tear Strength ASTM 624 to determine tensile displacement at maximum load, force at maximum load, breaking factor, and displacement at break. Measurements were obtained for both MD Tear and TD Tear. The results are reported below in Table VI.

TABLE VI

| | | Sample 1 | Sample 2 | Control |
|---|---|---|---|---|
| MD | Tensile Strain | 136.45 | 138.36 | 120.35 |
| Tear | at maximum | | | |
| | load (%) | | | |
| | Force at | 26.04 | 24.45 | 19.86 |
| | maximum | | | |
| | load (N) | | | |
| | Breaking | 2.05 | 1.93 | 1.56 |
| | Factor | | | |
| | (N/mm) | | | |
| | Displacement | 82.97 | 80.48 | 73.71 |
| | at Break | | | |
| | (mm) | | | |
| TD | Tensile Strain | 112.16 | 122.25 | 103.70 |
| Tear | at maximum | | | |
| | load (%) | | | |
| | Force at | 39.87 | 35.39 | 26.33 |
| | maximum | | | |
| | load (N) | | | |
| | Breaking | 3.14 | 2.79 | 2.07 |
| | Factor | | | |
| | (N/mm) | | | |
| | Displacement | 84.50 | 95.72 | 75.55 |
| | at Break | | | |
| | (mm) | | | |

The data in Tables III through VI indicates the article made from Samples 1 and 2 have improved mechanical properties. These improved properties in theory allow for an extension of service life of the article and/or allow for reduced raw material usage.

It is to be understood that the appended claims are not limited to express any particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present disclosure independently and collectively fall within the scope of the appended claims and are understood to describe and contemplate all ranges including whole and/or fractional values therein, even if such values are not expressly written herein. One of skill in the art readily recognizes that the enumerated ranges and subranges sufficiently describe and enable various embodiments of the present disclosure, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The present disclosure has been described in an illustrative manner, and it is to be understood that the terminology which has been used is intended to be in the nature of words of description rather than of limitation. Many modifications and variations of the present disclosure are possible in light of the above teachings. The present disclosure may be practiced otherwise than as specifically described. The subject matter of all combinations of independent and dependent claims, both singly and multiply dependent, is herein expressly contemplated.

1. An insulated conduit comprising;
a pipe for transporting a fluid, the pipe defining an interior surface and an exterior surface;
a crosslinked insulation layer disposed about the exterior surface of the pipe; the crosslinked insulation layer comprising a polyethylene composition, the polyethylene composition having:
a density of from 0.9125 to 0.9200 (g/cm³) as measured in accordance with ASTM D792;
a melt flow ratio (MFR) of 30 to 70 as measured in accordance with ASTM D1238; and
a melt index of from 0.3 to 1.8 (I2.16 kg) as measured in accordance with ASTM D1238.

2. The insulated conduit as set forth in claim 1, wherein the polyethylene composition has a density of from 0.9125 to 0.9180 (g/cm³).

3. The insulated conduit as set forth in claim 2, wherein the polyethylene composition has a density of from 0.9125 to 0.9170 (g/cm³).

4. The insulated conduit as set forth in claim 1, wherein the polyethylene composition has a melt index of 0.3 to 1.5 (I2.16 kg).

5. The insulated conduit as set forth in claim 4, wherein the polyethylene composition has a melt index of 0.4 to 1.3 (I2.16 kg).

6. The insulated conduit as set forth in claim 1, wherein the polyethylene composition is derived from at least 85 mol. % of ethylene monomer units and the insulated conduit is used for HVAC applications.

7. The insulated conduit as set forth in claim 1, wherein the polyethylene composition has a melt flow rate of 35 to 65.

8. The insulated conduit as set forth in claim 1, wherein the polyethylene composition has a polydispersity index of from 2.0 to 3.5.

9. The insulated conduit as set forth in claim 1, wherein the polydispersity index is from 2.5 to 3.3.

10. The insulated conduit as set forth in claim 1, wherein the polyethylene composition has a melt index of 0.3 to 1.8 (I2.16 kg), a melt flow rate of 35 to 65, a polydispersity index of from 2.5 to 3.3, and a density of from 0.9125 to 0.9170 (g/cm³).

11. The insulated conduit as set forth in claim 1, wherein the polyethylene composition of the crosslinked insulation layer is formed from a polyethylene that prior to irradiation had a density of 0.9125 to 0.9200 (g/cm³), a melt flow ratio of 15 to 25, and a melt index of 2.0 to 10.0 (I2.16 kg).

12. The insulated conduit as set forth in claim 11, wherein the non-crosslinked polyethylene had a density of 0.9125 to 0.9170, a melt flow rate of 17 to 22, and a melt index of 3.0 to 6.5 (I2.16 kg).

13. The insulated conduit as set forth in claim 12, wherein the non-crosslinked polyethylene had a polydispersity index of from 2.2 to 2.7.

14. A method of forming an insulated conduit;
providing a pipe for transporting a fluid, the pipe defining an interior surface and an exterior surface;
providing a non-crosslinked polyethylene, the non-crosslinked polyethylene having a density of from 0.9125 to 0.9200 (g/cm³), a melt flow rate of from 15 to 25, and a melt index of from 2.0 to 10.0;
crosslinking the non-crosslinked polyethylene to form a polyethylene composition, the polyethylene composition having a density of from 0.9125 to 0.9200 (g/cm³) as measured in accordance with ASTM D792, a melt flow ratio (MFR) of 30 to 70 as measured in accordance with ASTM D1238; and a melt index of from 0.3 to 1.8 (I2.16 kg) as measured in accordance with ASTM D1238;
disposing the polyethylene composition about the exterior surface of the pipe to form an insulated layer about the conduit.

15. The method as set forth in claim 14, wherein the non-crosslinked polyethylene has a density of 0.9125 to 0.9170, a melt flow rate of 17 to 22, and a melt index of 3.0 to 6.5 (I2.16 kg).

16. The method as set forth in claim 14, wherein the polyethylene composition has a density of from 0.9125 to 0.9180 (g/cm³).

17. The method as set forth in claim 14, wherein the polyethylene composition has a melt index of 0.3 to 1.5 (12.16 kg).

18. The method as set forth in claim 14, wherein the polyethylene composition has a melt flow rate of 35 to 65.

19. The method as set forth in claim 18, wherein the polyethylene composition has a polydispersity index of from 2.0 to 3.5.

20. The method as set forth in claim 14, wherein the polyethylene composition has a melt index of 0.3 to 1.5 (I2.16 kg), a melt flow rate of 35 to 65, a polydispersity index of from 2.3 to 2.5, and a density of from 0.9125 to 0.9170 (g/cm³).

21. The method as set forth in claim 14, wherein crosslinking further comprises irradiating the non-crosslinked polyethylene composition to form the polyethylene composition.
